(19) United States
(12) Patent Application Publication
(10) Pub. No.: US 2004/0042426 A1
(43) Pub. Date: Mar. 4, 2004

(54) Communication device and method for frame reconstruction among soft handoff legs

(76) Inventors: John M. Harris, Chicago, IL (US); Tyler A. Brown, Mundelein, IL (US); Lee M. Proctor, Cary, IL (US); Robert D. Battin, Kildeer, IL (US)

Correspondence Address: MOTOROLA, INC., 1303 EAST ALGONQUIN ROAD, IL01/3RD, SCHAUMBURG, IL, 60196

(21) Appl. No.: 10/232,061

(22) Filed: Aug. 30, 2002

(51) Int. Cl. H04Q 7/00; H04J 3/24

(52) U.S. Cl. 370/331; 370/474

(57) ABSTRACT

The present invention addresses the need for a device and method of frame reconstruction among soft handoff legs that improves the reliability of received information without reducing RF capacity. Given received frames from each leg of a soft handoff (300-303) a reconstructed frame (304) is produced. Subframes (e.g., 362) with passing inner frame quality indicators (352) are selected for the reconstructed frame. For portions of the reconstructed frame (e.g., 324 and 344) that do not have corresponding portions in the leg frames with passing inner frame quality indicators, a bit-wise majority rule is applied to select values.

### FIELD OF THE INVENTION

The present invention relates generally to wireless communication and, in particular, to frame reconstruction among soft handoff legs.

### BACKGROUND OF THE INVENTION

To provide continuous communication in wireless communication systems, such as cellular communication systems, a mobile unit must be handed off from one coverage area to a neighboring coverage area as the mobile unit travels across coverage area boundaries. There are several types of handoff arrangements. Hard handoffs typically involve communication between a mobile unit and two base sites such that the mobile unit only communicates with one base site at a time. In contrast, soft handoffs typically involve simultaneous communication between the mobile unit and multiple base sites, while softer handoffs involve communication between the mobile unit and multiple base transceivers, some of which support individual sectors at the same base site.

In code division multiple access (CDMA) systems, during a soft handoff (or a softer handoff), mobile unit transmissions are received by multiple base transceivers. Furthermore, each of these base transceivers transmits the same information to the mobile unit but spread with independent spreading sequences. Thus, during a soft handoff, there are multiple receive legs (at both the mobile unit and in the fixed infrastructure) from which the received information can be obtained. In other words, each transmitted frame is received by each individual soft handoff leg. These individually received frames (i.e., leg frames) each correspond to the same transmitted frame. From these corresponding leg frames, a reconstructed frame representing the originally transmitted information is typically generated.

Within cellular communication systems, voice quality is often perceived by the user as the most important attribute to any call. Cellular providers along with equipment manufacturers continuously strive to improve voice quality within cellular communication systems. Usually a higher quality voice channel requires more Radio Frequency (RF) capacity, thereby limiting the total number of services a system can simultaneously provide. Thus, system capacity often must be traded-off to increase quality. For example, in CDMA systems, the transmit power can be boosted or the transmitted information can be encoded with greater redundancy to reduce the number of air frames that are lost or that must be retransmitted. However, techniques such as these reduce the RF capacity of CDMA systems. In contrast, techniques for increasing the reliability of information as it is received that do not require additional RF capacity are particularly desirable. Therefore, a need exists for a device and method of frame reconstruction among soft handoff legs that improves the reliability of received information without reducing RF capacity.

### BRIEF DESCRIPTION OF THE DRAWINGS

FIG. 1 is a block diagram depiction of a communication system in accordance with an embodiment of the present invention.

FIG. 2 is a logic flow diagram of steps executed in accordance with an embodiment of the present invention.

FIG. 3 is an illustration of a frame reconstruction from soft handoff leg frames in accordance with an embodiment of the present invention.

### DETAILED DESCRIPTION OF EMBODIMENTS

The present invention addresses the need for a device and method of frame reconstruction among soft handoff legs that improves the reliability of received information without reducing RF capacity. Given received frames from each leg of a soft handoff, a reconstructed frame is produced. Subframes with passing inner frame quality indicators are selected for the reconstructed frame. For portions of the reconstructed frame that do not have corresponding portions in the leg frames with passing inner frame quality indicators, a bit-wise majority rule is applied to select values.

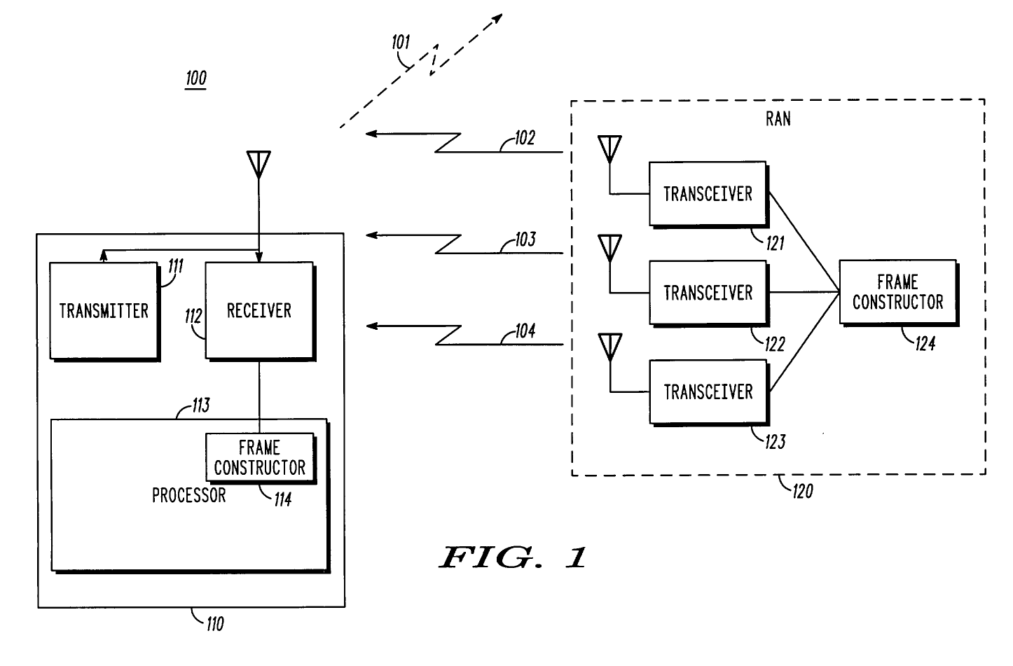

The disclosed embodiments can be more fully understood with reference to FIGS. 1-3. FIG. 1 is a block diagram depiction of a communication system 100 in accordance with a first embodiment of the present invention. Communication system 100 is a well-known Code Division Multiple Access (CDMA) system, specifically a CDMA 2000 system, which is based on the Telecommunications Industry Association/Electronic Industries Association (TIA/EIA) standard IS-2000, suitably modified to implement the present invention. However, the present invention is not limited to a particular wireless technology. For example, the present invention may be applied whenever the same transmitted data is transmitted or received by multiple devices thereby creating multiple receive frames that need to be combined into a single receive frame. Therefore, in alternate embodiments, communication system 100 may utilize other communication system protocols such as, but not limited to, UMTS, 1× EVDV, and 1× EVDO.

The first embodiment of the present invention includes radio access network (RAN) 120 and remote units, such as mobile station (MS) 110. However, the present invention is not limited to remote units that are mobile. For example, a remote unit may comprise a desktop computer wirelessly connected to the radio access network.

Those skilled in the art will recognize that FIG. 1 does not depict all of the network equipment necessary for system 100 to operate but only those logical entities particularly relevant to the description of embodiments of the present invention. For example, RAN 120 comprises well-known entities such as transceivers 121-123, and frame constructor 124. Those skilled in the art are aware of the many ways each of these entities can be implemented and/or purchased from wireless communications companies such as “MOTOROLA.” Frame constructors, for example, typically comprise components such as processors, memory, and/or logic circuitry designed to implement algorithms that have been expressed as computer instructions and/or in circuitry. Given an algorithm or a logic flow, those skilled in the art are aware of the many design and development techniques available to implement a frame constructor that performs the logic.

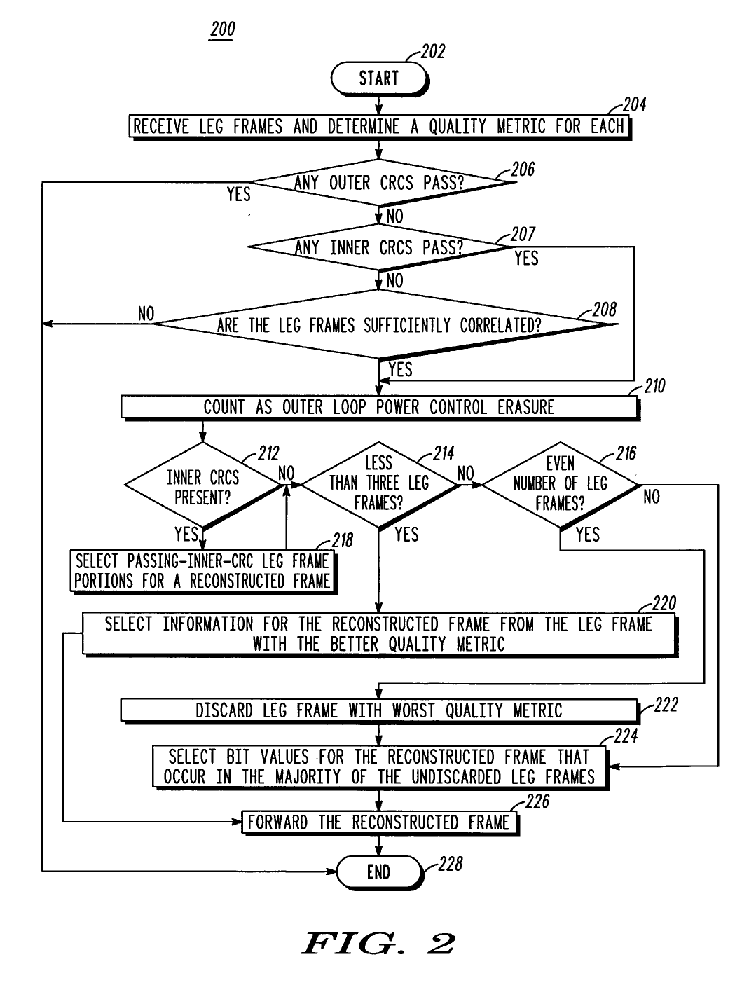

Typically, RAN transceivers are components of RAN base transceiver stations (BTSs), which interface with devices such as base site controllers (BSCs), frame selection and distribution units (SDUs) mobile switching centers/virtual location registers (MSCNLR), home location registers (HLR), etc. In a first embodiment of the present invention, a known CDMA 2000 RAN is adapted using known telecommunications design and development techniques to implement the logic of the present invention. The result is RAN 120, which performs the method described with respect to FIG. 2. Those skilled in the art will recognize that the present invention may be implemented in and across various physical components of RAN 120. For example, frame constructor 124 may be implemented in a base site or an SDU.

RAN 120 and MS 110 communicate via CDMA 2000 air interface resources 101-104. In the first embodiment of the present invention, MS 110 comprises transmitter 111, receiver 112, processor 113, and frame constructor 114. Processor 113 includes components such as memory, programming, and microprocessor devices. Frame constructor 114 is physically implemented by the components that makeup processor 113. Transmitters, receivers, processors, and frame constructors as used in CDMA MSs are common and well known in the art. In a first embodiment of the present invention, a known CDMA 2000 MS is adapted using known telecommunications design and development techniques to implement the logic of the present invention. The result is MS 110, which also performs the method described with respect to FIG. 2.

When MS 110 is involved in a soft/softer handoff, it transmits uplink frames via wireless link 101. A transceiver in each of the base sites and/or individual sectors involved in the handoff (i.e., transceivers 121-123) receives the transmitted frames. Similarly, transceivers 121-123 transmit downlink frames via wireless links 102-104, respectively, and receiver 112 receives each of the transmitted frames from each of the transceivers. Thus, there are three leg frames received by RAN 120 for each uplink frame transmitted, and three leg frames received by MS 110 for each downlink frame sent to MS 110. Frame constructors 114 and 124 forward a single frame corresponding to the originally transmitted frame using each of the received leg frames. Frame constructors 114 and 124 do this according to logic flow 200.

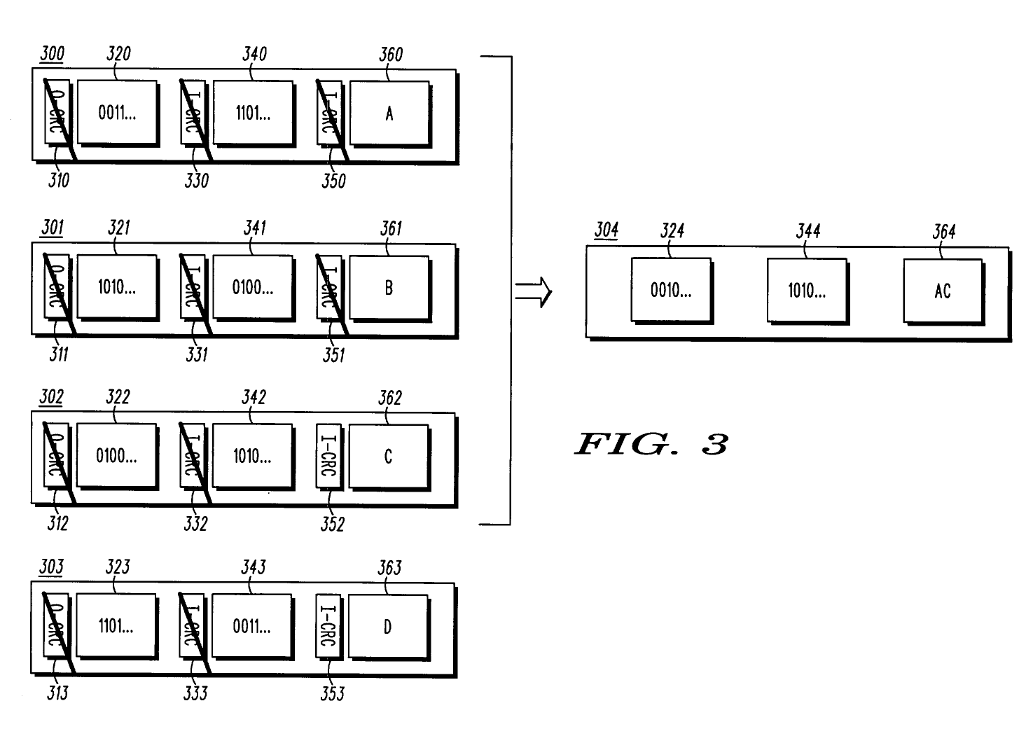

FIG. 2 is a logic flow diagram of steps executed in accordance with a first embodiment of the present invention. Logic flow 200 is more clearly described with reference to FIG. 3, illustrating received leg frames 300-303 and reconstructed frame 304, which is forwarded. Logic flow 200 begins (202) when leg frames 300-303, for example, are received (204). Each leg frame 300-303 includes an outer frame quality indicator (FQI) that indicates a frame quality of the frame as a whole. Although any FQI may be used, the first embodiment utilizes cyclical redundancy checking (CRC). Thus, the outer FQIs are outer (CRCs) 310-313. Similarly, each leg frame 300-303 includes multiple inner frame quality indicators (FQI) that each indicate a frame quality of a portion of each leg frame 300-303. Again, although any FQI may be used, the first embodiment utilizes CRCs. Thus, inner CRCs 330-333 and 350-353 each indicate the quality of subframes 340-343 and 360-363, respectively.

As leg frames 300-303 are received (204), well-known receive quality metrics, such as the symbol error rate (SER) and total metric (TM), are determined for each leg frame. As illustrated in FIG. 3 leg frame 303 is considered to have the worst receive quality metric (e.g., the worst TM and/or SER). Outer CRCs 310-313 and inner CRCs 330-333 and 350-353 are also checked. However, as indicated by the slashes in FIG. 3, outer CRCs 310-313 and inner CRCs 330-333, 350, and 351 all fail. Since some CRCs did pass (206 and 207), correlating the leg frames is not necessary. If none of the leg frame CRCs had passed then the leg frames would be correlated (208) to determine whether a frame was actually transmitted, i.e., a non-DTX frame. When the correlation indicates that the leg frames comprise transmitted information, the frame is counted (210) as an outer loop power control erasure, since none of the leg frame outer CRCs passed.

Even though a transmitted frame may be considered an erasure, a frame can still be reconstructed from the received leg frames, in accordance with the present invention. Clearly, if a reliable frame can be reconstructed from an erased frame, then quality is improved without using any additional RF capacity. The composition of reconstructed frame 304 is determined as follows in accordance with the first embodiment of the present invention.

Inner CRCs are present (212) in leg frames 300-303 and inner CRCs 352 and 353 have passed, indicating that leg frame portions 362 and 363 are of acceptable quality. Thus, subframes 362 and 363 presumably contain the same information, and are selected for reconstructed frame 304 as subframe 364. However, it is possible that subframes 362 and 363 do not contain the same information. This could occur in the case where a CRC passes falsely. Therefore, the subframe with a passing CRC from the leg frame with the best receive quality metric may be chosen. Since leg frame 303 has the worst receive quality metric, subframe 362 is selected for subframe 364 rather than subframe 363.

For portions of the leg frames for which there is no inner CRC or all inner CRCs have failed, one of two approaches is taken in the first embodiment to recover the transmitted information. When less than three leg frames (214) have been received, information is selected (220) from the leg frame with the better receive quality metric. For example, if only leg frames 302 and 303 had been received, information for subframe 324 and 344 would be selected from subframes 322 and 342, respectively, rather than from subframes 323 and 343, since leg frame 302 has the better receive quality metric.

When three or more leg frames have been received, as illustrated in FIG. 3, a bit-wise majority rule is applied. In order to apply this majority rule, however, an odd number of leg frames is needed for consideration. Thus, when an even number have been received (216), the leg frame having the worst receive quality metric is discarded (222), i.e., not considered. Leg frame 303 is thus not considered when applying the bit-wise majority rule.

Instead, for each bit in reconstructed frame 304 that corresponds to a bit in each of the leg frames 300-302 for which there is no passing inner CRC, the bit value represented by the majority of the corresponding bits is selected (224). For example, the first bits of subframes 320-322 correspond to the first bit of subframe 324 of the reconstructed frame 304. Applying the bit-wise majority rule results in a “0” for the first bit of subframe 324, since the first bits of subframes 320-322 are “0”, “1”, and “0”, respectively. Again, this rule is applied to select values for each bit in reconstructed frame 304 that corresponds to a bit in each of the leg frames 300-302 for which there is no passing inner CRC. Thus, subframes 324 and 344 of reconstructed frame 304 are determined in this manner. The bit values shown in subframes 324 and 344 are consistent with the application of the bit-wise majority rule to subframes 320-322 and 340-342 of leg frames 300-302. Once completed, reconstructed frame 304 is then forwarded (226) for further communication processing.

Reconstructed frame 304 represents a best determination of the information originally transmitted. By embodying the present invention, such as described above, the reliability of received information can be improved without reducing RF capacity. Reconstructed frames can be created from the received leg frames even when the frames would otherwise be discarded as erasures.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically or electrically. The term “program” (or “programming”), as used herein, is defined as a sequence of instructions designed for execution on a computer system. A program, programming, or computer program, may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A method for frame reconstruction among soft handoff legs comprising:
receiving a first leg frame and a second leg frame, wherein the first leg frame and the second leg frame each comprise an outer frame quality indicator (FQI) that indicates a frame quality of the frame as a whole;
determining a receive quality metric for the first leg frame and the second leg frame;
determining a frame quality for the first leg frame and the second leg frame using the outer FQI of the first leg frame and the second leg frame, respectively; and
when the frame quality for the first leg frame and the second leg frame are both unacceptable and no additional frames from additional soft handoff legs have been received,
determining whether the first leg frame or the second leg frame has a better receive quality metric and
forwarding a reconstructed frame comprising information selected from the leg frame with the better receive quality metric.

2. The method of claim 1, wherein each of the outer frame quality indicators comprises a cyclical redundancy checking (CRC) indicator and wherein frame quality is unacceptable when a CRC check fails.

3. The method of claim 1, wherein the receive quality metric comprises a total metric.

4. The method of claim 1, wherein the receive quality metric comprises a symbol error rate.

5. The method of claim 1, further comprising when the frame quality or the first leg frame and the second leg frame are both unacceptable, determining a correlation between the first leg frame and the second leg frame and when the correlation indicates that the first leg frame and the second leg frame comprise transmitted data, counting the first leg frame and the second leg frame as an outer loop power control erasure.

6. The method of claim 1,
wherein the first leg frame and the second leg frame each comprise an inner FQI that indicates a frame quality of a portion of each frame,
wherein the method of claim A further comprises determining a frame quality of the portion of the first leg frame and of the portion of the second leg frame using the inner FQI of each of the first leg frame and the second leg frame, respectively,
wherein the reconstructed frame comprises information selected from the leg frame with the better receive quality metric for the portion of the first leg frame and the second leg frame having unacceptable inner-FQI-determined frame qualities, and
wherein the reconstructed frame comprises information selected from the leg frame with the portion having an acceptable inner-FQI-determined frame quality for the portion having an acceptable inner-FQI-determined frame qualities.

7. The method of claim 6, wherein each of the inner frame quality indicators comprises a cyclical redundancy checking (CRC) indicator and wherein an unacceptable inner-FQI-determined frame quality comprises a failed CRC check.

8. The method of claim 6, further comprising when the frame quality for the first leg frame, the second leg frame, and inner-FQI-determined frame qualities are all unacceptable, determining a correlation between the first leg frame and the second leg frame and when the correlation indicates that the first leg frame and the second leg frame comprise transmitted data, counting the first leg frame and the second leg frame as an outer loop power control erasure.

9. A method for frame reconstruction among soft handoff legs comprising:
receiving a first leg frame, a second leg frame, and a third leg frame, wherein the first leg frame, the second leg frame, and the third leg frame each comprise an outer frame quality indicator (FQI) that indicates a frame quality of the frame as a whole;
determining a frame quality for the first leg frame, the second leg frame, and the third leg frame using the outer FQI of the first leg frame, the second leg frame, and the third leg frame, respectively; and
when the frame quality for the first leg frame, the second leg frame, and the third leg frame are all unacceptable,
selecting, for each bit in a reconstructed frame that corresponds to a bit in each of the first leg frame, the second leg frame, and the third leg frame, a bit value that is represented by a majority of the corresponding bits in each of the first leg frame, the second leg frame, and the third leg frame and
forwarding the reconstructed frame.

10. The method of claim 9, wherein each of the outer frame quality indicators comprises a cyclical redundancy checking (CRC) indicator and wherein frame quality is unacceptable when a CRC check fails.

11. The method of claim 9, further comprising when the frame quality for the first leg frame, the second leg frame, and the third leg frame are all unacceptable, determining a correlation between the first leg frame, the second leg frame, and the third leg frame and when the correlation indicates that the first leg frame, the second leg frame, and the third leg frame comprise transmitted data, counting the first leg frame, the second leg frame, and the third leg frame as an outer loop power control erasure.

12. The method of claim 9,
wherein the first leg frame, the second leg frame, and the third leg frame each comprise an inner FQI that indicates a frame quality of a portion of each frame;
wherein the method of claim B further comprises determining a frame quality of the portion of the first leg frame, the portion of the second leg frame, and the portion of the third leg frame using the inner FQI of each of the first leg frame, the second leg frame, and the third leg frame, respectively;
wherein selecting comprises selecting, for each bit in the reconstructed frame that corresponds to a bit in each of the portion of the first leg frame, the portion of the second leg frame, and the portion of the third leg frame, a bit value that is represented by a majority of the corresponding bits in each of the portion of the first leg frame, the portion of the second leg frame, and the portion of the third leg frame, when all inner-FQI-determined frame qualities are unacceptable; and
wherein selecting comprises selecting, for each bit in the reconstructed frame that corresponds to a bit in each of the portion of the first leg frame, the portion of the second leg frame, and the portion of the third leg frame, a bit value from the corresponding bit in the portion of the first leg frame, when the inner-FQI-determined frame quality of the portion of the first leg frame is acceptable.

13. The method of claim 12, wherein each of the inner frame quality indicators comprises a cyclical redundancy checking (CRC) indicator and wherein an unacceptable inner-FQI-determined frame quality comprises a failed CRC check.

14. The method of claim 12, further comprising when the frame quality for the first leg frame, the second leg frame, the third leg frame, and all inner-FQI-determined frame qualities are unacceptable, determining a correlation between the first leg frame, the second leg frame, and the third leg frame and when the correlation indicates that the first leg frame, the second leg frame, and the third leg frame comprise transmitted data, counting the first leg frame, the second leg frame, and the third leg frame as an outer loop power control erasure.

15. A method for frame reconstruction among soft handoff legs comprising:
receiving at least three leg frames, each comprising an outer frame quality indicator (FQI) that indicates a frame quality of each leg frame as a whole;
determining a frame quality for each of the at least three leg frames using the outer FQI of each leg frame; and
when the frame quality for each of the at least three leg frames are all unacceptable,
selecting, for each bit in a reconstructed frame that corresponds to a bit in each of the at least three leg frames, a bit value that is represented by a majority of the corresponding bits in each of the at least three leg frames and
forwarding the reconstructed frame.

16. The method of claim 15, wherein when the frame quality for each of the at least three leg frames are all unacceptable and the at least three leg frames are an even number of leg frames, selecting, for each bit in a reconstructed frame that corresponds to a bit in each of the at least three leg frames, a bit value that is represented by a majority of the corresponding bits in each, except for one leg frame, of the at least three leg frames.

17. The method of claim 16, further comprising determining a receive quality metric for the at least three leg frames, wherein the leg frame of the at least three leg frames that is excepted is the leg frame having the worst receive quality metric of the at least three leg frames.

18. A communication device comprising:
at least one receiver adapted to receive a first leg frame and a second leg frame, and adapted to determine a receive quality metric for the first leg frame and the second leg frame, wherein the first leg frame and the second leg frame each comprise an outer frame quality indicator (FQI) that indicates a frame quality of the frame as a whole; and
a frame constructor, operably coupled to the at least one receiver, adapted to determine a frame quality for the first leg frame and the second leg frame using the outer FQI of the first leg frame and the second leg frame, respectively, and adapted to determine whether the first leg frame or the second leg frame has a better receive quality metric and to forward a reconstructed frame comprising information selected from the leg frame with the better receive quality metric, when the frame quality for the first leg frame and the second leg frame are both unacceptable and no additional frames from additional soft handoff legs have been received.

19. A communication device comprising:
at least one receiver adapted to receive a first leg frame, a second leg frame, and a third leg frame, wherein the first leg frame, the second leg frame, and the third leg frame each comprise an outer frame quality indicator (FQI) that indicates a frame quality of the frame as a whole;
a frame constructor, operably coupled to the at least one receiver, adapted to determine a frame quality for the first leg frame, the second leg frame, and the third leg frame using the outer FQI of the first leg frame, the second leg frame, and the third leg frame, respectively, and adapted to select, for each bit in a reconstructed frame that corresponds to a bit in each of the first leg frame, the second leg frame, and the third leg frame, a bit value that is represented by a majority of the corresponding bits in each of the first leg frame, the second leg frame, and the third leg frame and to forward the reconstructed frame, when the frame quality for the first leg frame, the second leg frame, and the third leg frame are all unacceptable.
